(19) United States
(12) Patent Application Publication
(10) Pub. No.: US 2008/0005947 A1
(43) Pub. Date: Jan. 10, 2008

(54) Golf mat with advertising area

(75) Inventors: Bruce A. Barna, Glenshaw, PA (US); Jared Wische, Trenton, NJ (US)

Correspondence Address: THE WEBB LAW FIRM, P.C., 700 KOPPERS BUILDING, 436 SEVENTH AVENUE, PITTSBURGH, PA, 15219, US

(73) Assignee: Infinite Links, LLC, Boynton Beach, FL (US)

(21) Appl. No.: 11/317,975

(22) Filed: Dec. 23, 2005

Related U.S. Application Data
(63) Continuation of application No. PCT/US04/20365, filed on Jun. 25, 2004.
(60) Provisional application No. 60/482,583, filed on Jun. 25, 2003.

(51) Int. Cl. G09F 3/02

(52) U.S. Cl. 40/629

(57) ABSTRACT

A golf mat for displaying advertising includes a first layer having a top surface and a bottom surface; a second layer having a top surface and a bottom surface, wherein the first layer is attached to the second layer; a recess extending into the top surface of the first layer; and an advertising element having advertising displayed thereon, wherein the advertising element is situated within the recess. The advertising element may be an electronic device having a display for electronically displaying the advertising thereon. Methods of manufacturing the present invention and displaying advertising utilizing the present invention are also disclosed.

### CROSS-REFERENCE TO RELATED APPLICATIONS

This application is a continuation in part application claiming priority to PCT Application No. PCT/US2004/020365 entitled “Golf Practice Mat With Advertising Area,” filed Jun. 25, 2004, which is incorporated herein by reference in its entirety, claiming priority to U.S. Provisional Application No. 60/482,583 filed Jun. 25, 2003.

### BACKGROUND OF THE INVENTION

1. Field of the Invention

The present invention relates to the retrofitting of new and existing golf practice mats for advertising to be displayed thereon.

2. Description of Related Art

Golf practice mats are used in driving ranges, golf courses, country clubs and anywhere golfers may practice. Such mats are typically made from a hard, weather resistant plastic material and may have a portion of artificial grass.

Because many individuals use these mats throughout the course of time, the golf mats offer a suitable station in which to insert or place advertising or even messages. U.S. Pat. No. 5,443,870 discloses a golf mat with a permanent printed advertising area. However, the prior art lacks the ability to retrofit old mats that are currently being used for practice and existing mats that do not have a printed advertisement or message area. Additionally, the prior art neither allows for different shapes of advertising nor the ability to change the advertising area once it is in place.

### SUMMARY OF THE INVENTION

Golf practice mats are usually constructed of at least a hard, weather resistant, plastic material as a base and may have synthetic plastic grass/turf surface and may include a teeing area and an area in which the golfer stands. The present invention includes a golf mat that has an area eradicated using a router that can accept an inserted printed message or advertising element. The golf mat may be retrofitted to accommodate the printed message or advertising element or a new golf mat may be originally constructed so as to receive the printed message or advertising element. The printed message or advertising element may be placed in a way that it is temporarily secured or permanently secured to the golf mat. The advertising element may be an electronic device for dynamically displaying advertising content on the golf mat.

Specifically, the present invention includes a golf mat for displaying advertising, wherein the golf mat includes a first layer having a top surface and a bottom surface; a second layer having a top surface and a bottom surface, wherein the first layer is attached to the second layer; a recess extending into the top surface of the first layer; and an advertising element having advertising displayed thereon, wherein the advertising element is secured within the recess. The first layer may be constructed of a synthetic turf material and the second layer may be constructed of a plastic and rubber material. A fastener or adhesive may be utilized to secure the advertising element within the recess. The recess may also extend into the top surface of the second layer. In this instance, the golf mat may also include a base substantially conforming to the lateral shape of the recess. Thus, the base may also be secured within the recess, whereas the advertising element is secured to the base. The advertising element may be an electronic device having a display for displaying an electronic advertisement. The electronic advertisement may be text, a static image, and/or a video. The electronic device may include a receiver for wirelessly receiving the electronic advertisement.

An alternative embodiment of the present invention includes a device for displaying advertising on a golf playing surface, wherein the device includes another advertising element having a top side and a bottom side, wherein the top side includes advertising displayed thereon. The bottom side may include a plurality of prongs extending therefrom, wherein the plurality of prongs are adapted to penetrate the golf playing surface to secure the advertising element thereto.

Methods of manufacturing the present invention and displaying advertising utilizing the present invention are also disclosed. Furthermore, a kit for retrofitting an existing golf mat to display advertising is disclosed.

A method for displaying an electronic advertisement in association with the golf mat includes providing a golf mat including an electronic device having an electronic display associated therewith; and displaying the electronic advertisement on the electronic display. The electronic advertisement may include, but is not limited to a textual advertisement, an electronic static image advertisement, and an electronic video advertisement. Furthermore, advertising content may be transmitted from a communications device to the electronic device. The advertising content may include one or more electronic advertisements. Programming instructions or data may be transmitted to the electronic device. The programming instructions may be operative on the display settings of the electronic advertisements. Additionally, statistical data may be received from the electronic device. The statistical data includes information relating to the display of the electronic advertisements. The electronic advertisement may be transmitted to the electronic device via a distributed communications network from a service provider remotely and communicatively connected to the electronic device.

These and other advantages of the present invention will be understood from the following description of the preferred embodiments, taken with the accompanying drawings, wherein like reference numerals represent like elements throughout.

### BRIEF DESCRIPTION OF THE DRAWINGS

FIG. 1 is a front perspective view of a golf mat having advertising displayed thereon in accordance with the preferred embodiment of the present invention;

FIG. 2 is a front perspective exploded view of an advertising element and the golf mat depicted in FIG. 1;

FIG. 3 is a front perspective view of various elements of a kit for retrofitting an existing golf mat to display advertising thereon in accordance with the present invention;

FIGS. 4-8 depict a method of displaying advertising in association with existing golf mats in accordance with the present invention;

FIG. 9 is a front perspective view of a first alternative embodiment of the present invention in accordance with the present invention;

FIG. 10 is a front perspective view of a second alternative embodiment of the present invention in accordance with the present invention.

FIG. 11 is a front perspective exploded view of an advertising element embodied as an electronic device in the golf mat depicted in FIG. 1;

FIG. 12 is a schematic view of a golf mat advertising system in accordance with a first embodiment of the present invention;

FIG. 13 is a schematic view of a golf mat advertising system in accordance with a second embodiment of the present invention; and

FIG. 14 is a schematic view of a golf mat advertising system in accordance with a third embodiment of the present invention.

### DETAILED DESCRIPTION OF THE INVENTION

The preferred embodiments below include explanations and examples and are not to be construed as being limiting but merely as illustrative so as to teach the invention. Other than where indicated, all numbers or expressions referring to quantities used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

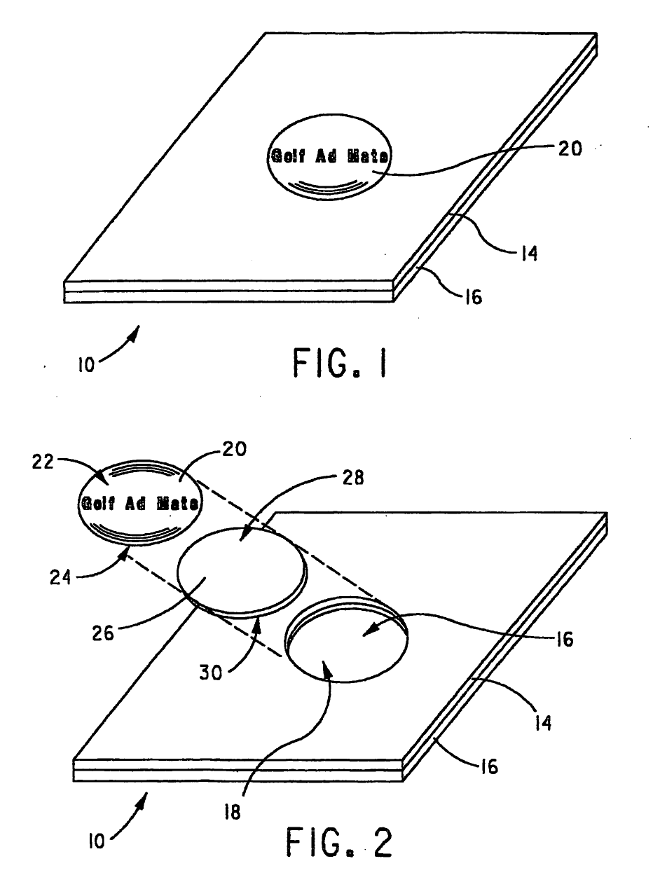

A golf mat 10, according to the present invention, is illustrated in FIGS. 1-2. As depicted in FIGS. 1-2, the golf mat 10 may serve as a teeing or putting area as well as an area in which a golfer may stand. Desirably, the golf mat 10 is constructed of a first layer 14 and a second layer 16. The first layer 14 is constructed of a synthetic grass or turf material such as nylon, plastic, polyethylene, etc. The second layer 16 is constructed of a hard, weather-resistant material, such as plastic or foam rubber material. It is to be understood that the aforementioned construction materials are not to be construed as limiting the invention. In relation to the ground on which the golf mat 10 is situated, the first layer 14 is the top layer and the second layer 16 is the bottom layer. A standard size for the golf mat 10 is usually 5′ by 5′ square and 1.25″ thick, although it is to be understood that the size of the golf mat 10 may vary based upon application of the golf mat 10 and/or the requirements of the golfer.

The golf mat 10 further includes a recess 18 that is sized to accommodate an advertising element 20 therein. Specifically, the recess 18 may extend into either the first layer 14 or both the first layer 14 and the second layer 16 of the golf mat 10. Thus, the advertising element 20 may be situated within either the first layer 14 or both the first layer 14 and the second layer 16. Although the recess 18 may be sized larger depth-wise than the advertising element 20, it is desirable for the recess 18 to substantially conform to the lateral shape of the advertising element 20 and/or vice versa.

The advertising element 20 may include a top side 22 and a bottom side 24. The advertising element 20 includes advertising displayed thereon, desirably on the top side 22. The advertising may include, but is not limited to an advertising message, a logo, or a combination thereof. The advertisement may be imprinted directly onto the advertising element 20 or onto an advertising insert that may be inserted behind a clear surface of the advertising element 20 to be visible therethrough. The advertisement may be imprinted through various known printing methods including, but not limited to, heat-transfer, ink, silk-screen printing, painting, and/or combinations thereof. For example, if the advertisement exists on a fabric member, the fabric member may be attached to the advertising element 20 by way of an adhesive. Alternatively, if the fabric member is already attached to a rubberized mouse-pad type backing, then the rubberized mouse-pad type backing may be cut to accommodate the lateral shape of the recess 18. In this instance, it is to be understood that the combination of the fabric member and the backing act as the advertising element. In any event, it is to be understood that the advertising element 20 may be constructed of any suitable material, depending on the advertisement and weather conditions to which the golf mat may be exposed. Various materials include, but are not limited to, metals, fabrics, rubbers, plastics, and/or combinations thereof.

In one particular embodiment of the invention, the advertising element 20 may be combined with an optional base 26 having a top side 28 and a bottom side 30. Specifically, the base 26 is situated within the recess 18 and supports the advertising element 20 thereon. Desirably, the bottom side 30 of the base 26 is permanently secured within the recess 18. Specifically, depending upon the depth of the recess 18, the bottom side 30 of the base 26 may be secured to either the first layer 14 or the second layer 16 of the golf mat 10. For example, as shown in FIG. 2, due to the depth of the recess 18 extending through the first layer 14 and into the second layer 16, the base 26 is secured to the second layer 16 of the golf mat 10. The base 26 may be secured to the second layer 16 in a permanent manner by utilizing various fasteners, adhesives, or other techniques including, but not limited to, bonding agents, nails, screws, brackets, rivets, or stamping. The top side 28 of the base 26 is secured to the bottom side 24 of the advertising element 20. The advertising element 20 may be secured to the base 26 in a temporary manner by utilizing various fasteners, adhesives, or other techniques including, but not limited to, hook and loop fasteners (e.g., Velcro® brand hook and loop fasteners hooking tape), hook and eye closures, button and eye fasteners, snap fasteners, removable tape, putty, and magnets. For example, in the instance of Velcro® brand hook and loop fasteners hooking tape, the hooking tape may be securely attached to the bottom side 24 of the advertising element 20. Alternatively, the hooking tape may be secured to either the top side 28 of the base 26 or either the first layer 14 or the second layer 16 exposed within the recess 18 of the golf mat 10. The loop tape portion may then be securely attached to either the bottom side 24 of the advertising element 20, or the top side 28 of the base 26, or either the first layer 14 or the second layer 16 exposed within the recess 18—whichever of the previous elements does not have the hooking tape already attached to it. As is the case with the advertising element 20, it is desirable for the base 22 to substantially conform to the lateral shape of the recess 18, so that the base 22 can be situated within the recess 18 and effectively support the advertising element 20. It is to be understood that the advertising element 20 need not be secured within the recess 18 by a fastener or the like, as the advertising element 20 may simply be seated within the recess 18.

It is to be understood that the size and/or shape of the advertising element 20 are only limited by the size and depth of the golf mat 10. Non-limiting examples of sizes and shapes include circles, squares, triangles, hexagons, octagons, shapes with a plurality of sides, shapes resembling clouds, animals, food, vehicles, plants, and flowers. Non-limiting sizes include shapes that would fit inside circles with diameters ranging between about 2 to about 16 inches. The printed message or advertising element 20 is usually flat in nature and may have a thickness of up to about an inch. The thickness is dependent on the type of material used to create the printed message or advertising element 20. It is to be understood that the advertising element 20 does not interfere with the functional aspects of the mat. For example, in order to prevent a golf club from striking the advertising element 20, it is intended that advertising element 20 is secured within the golf mat 10 so that the top of the advertising element 20 does not extend beyond the surface level of the first layer 14. Additionally, the advertising element 18 may be placed in any area of the golf mat 10 and therefore, the central location of the advertising element 20 depicted in FIGS. 1-2 is only shown for exemplary purposes.

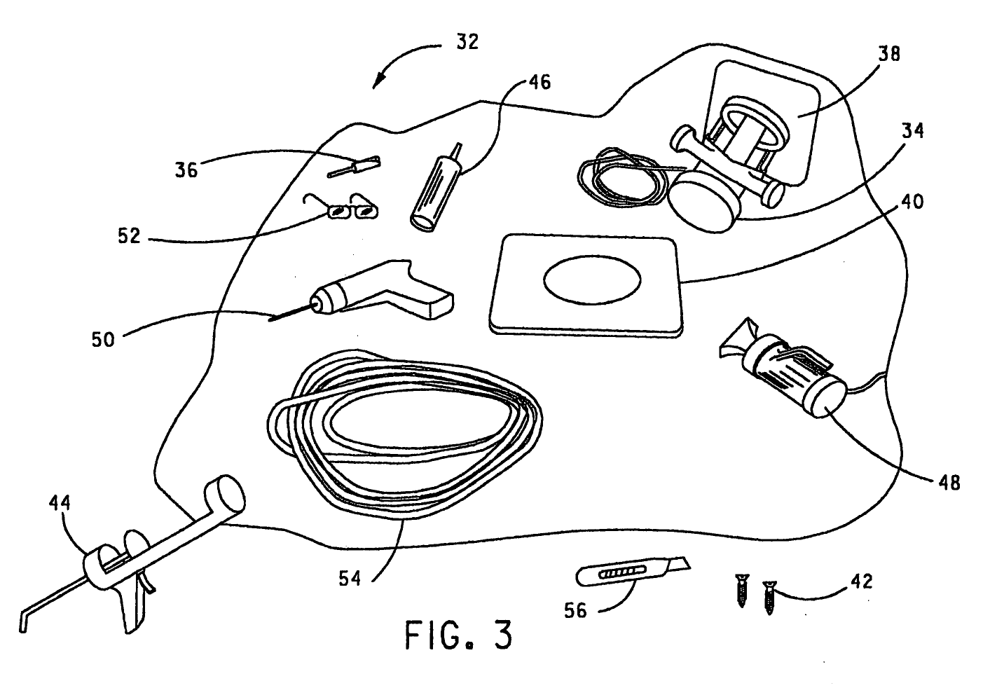

FIG. 3 depicts various equipment and supplies of a kit 32 for allowing an installer to retrofit an existing golf mat. It is to be understood that a standard golf mat includes neither the recess 18 nor the advertising element 20 and/or the base 26. Thus, the kit 32 is conducive to retrofitting an existing golf mat without advertising to the golf mat 10 of FIGS. 1-2, which does include advertising. The equipment and supplies of the kit 32 may include, but are not limited to the following. A router 34 is provided having a top portion and a bottom portion. A router bit 36 is adapted to be received by the bottom portion of the router 34. The router bit 36 is conducive to removing the necessary amount of the first layer 14 or first layer 14 and second layer 16 of the golf mat 20 to create the recess 18. A shield 38 is attached to the bottom portion of the router 34. In addition to aiding the router 34 during the removal of portions of the golf mat 10, the shield 38 prevents the removed portions of the golf mat 10 to be ejected toward the installer as debris. The shield 38 may be constructed to materials including, but not limited to, fiberglass, plastic, steel, or wood. Desirably, the shield 38 is transparent, so that the installer may observe the removal process. A template 40 includes a cut-out substantially corresponding to the lateral shape of the advertising element 20. Thus, the template is adapted to receive the router bit 36 through the cut-out. The template is adapted to be removably secured to the golf mat 10 by one or more fasteners 42. The fastener 42 may include, but is not limited to, a screw, nail, hook and loop type fastener, magnet, and clamp. For example, in the preferred embodiment, 1¼″ thread sheet rock screws are utilized. The kit 32 may also include a caulking gun 44 and suitable adhesive 46 for securing the base 26 to the golf mat 10. The actual base 26 or material for cutting out an appropriately sized base may also be provided. A suctioning device 48, such as a hand-held vacuum cleaner, for efficient removal of debris may also be provided. The kit 32 may contain other miscellaneous supplies that allow for increased efficiency and safety during the retrofitting process. For example, a power drill 50, safety glasses 52, an extension cord 54, and/or a utility knife 56 may be included in the kit 32.

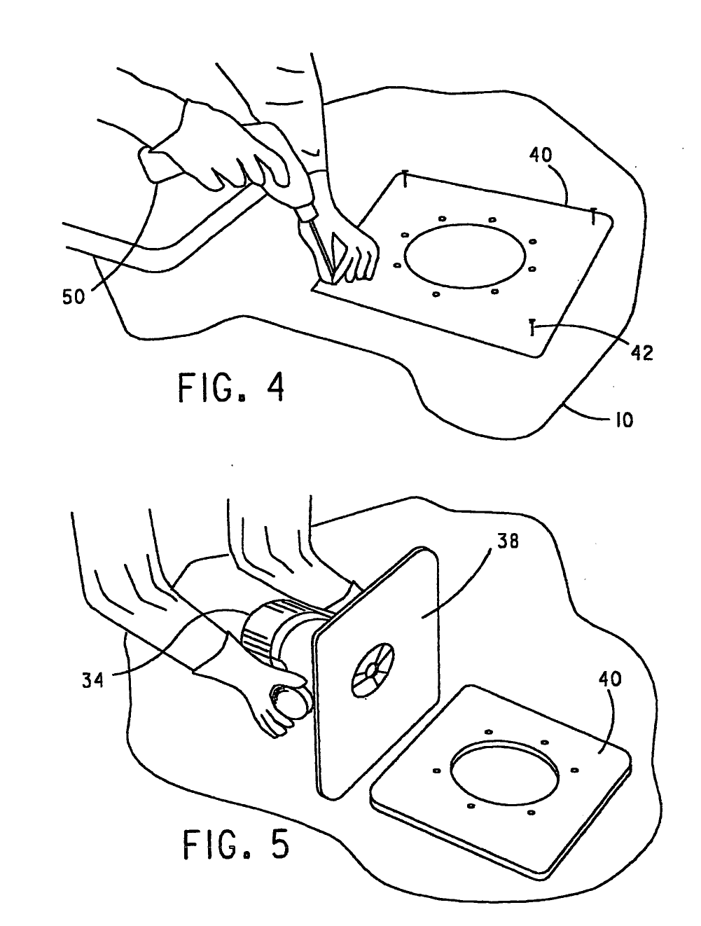

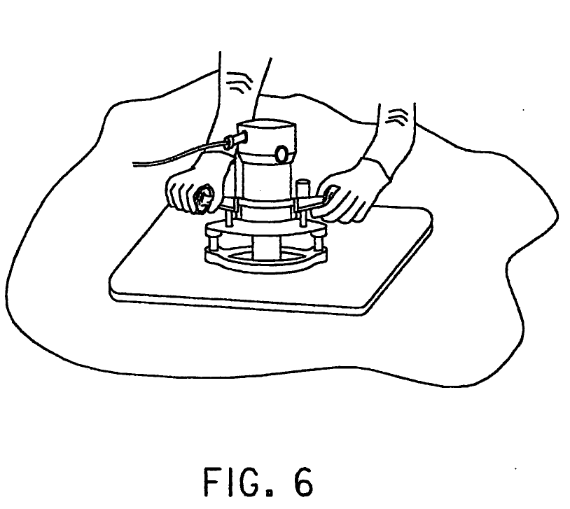

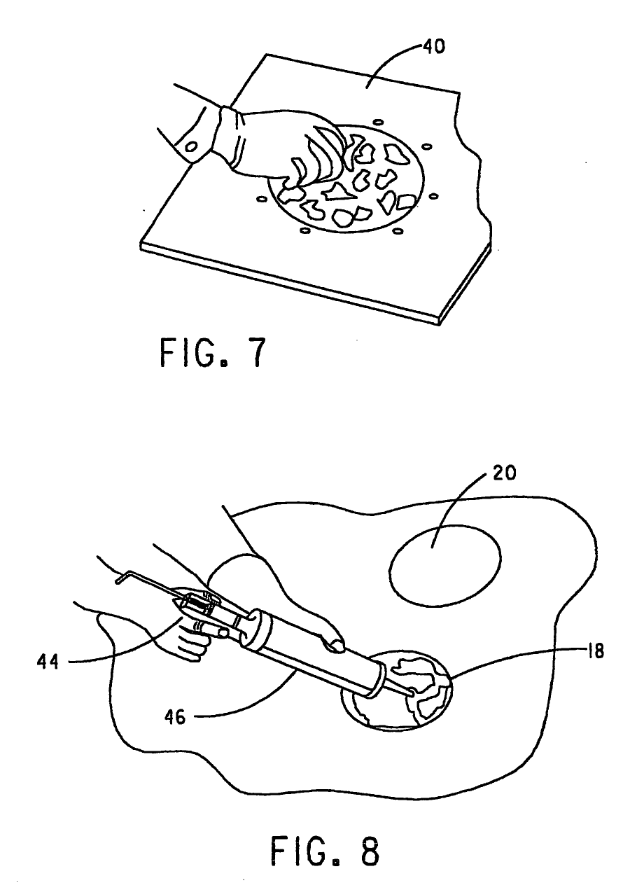

With reference to FIGS. 4-8 and with continuing references to FIGS. 1-3, the method of retrofitting new and existing golf practice mats will now be described. It is to be understood that newly created golf mats may be retrofitted any time after manufacture. Non-limiting examples include at the factory, during distribution, and at the end user's facility. Existing golf mats that are currently being used in golfing environments may be retrofitted as well. First, the installer selects a golf mat 10 to be retrofitted. Optionally, the installer may check the condition of an existing or used golf mat to ensure that it may be properly retrofitted. The installer then identifies a location on the golf mat 10 in which the advertisement is to be displayed. The portion of at least the first layer 14 of the golf mat 10 corresponding to the location for displaying the advertising is then prepared to be removed. Specifically, as shown in FIG. 4, the installer secures the template 40 to the golf mat 10 via the fasteners 42, either manually or by utilizing the power drill 50. Next, as shown in FIG. 5, the installer aligns the shield 38 of the router 34 with the template 40 so that the router bit 36 extends through the cut-out of the template 40. Thereafter, the installer may begin removing the portion of the first layer 14 or portions of both the first layer 14 and second layer 16 of the golf mat 10 by utilizing the template 40 as a guide and the router 34 as a removal tool, as shown in FIG. 6. In practice, the artificial grass fibers of the golf mat 10 and optionally the plastic or rubber material corresponding to the surface area underneath the cut-out of the template 40 are removed by the router 34. As shown in FIG. 7, periodically, debris accumulating from the removed portion of the golf mat 10 may be removed from the newly created recess 18 by utilizing the suctioning device 48. At this point, the advertising element 20 may be secured directly within the recess 18 via any of the temporary or permanent fasteners or adhesives previously discussed. Alternatively, if the base 26 is used, the recess 18 may be filled with the adhesive 46 via the caulking gun 44, as shown in FIG. 8. Thereafter, the base 26 is secured within the recess 18. The advertising element 20 may then be inserted into the recess and may be secured to the base 26 either temporarily or permanently. It is to be understood that if the existing golf mat does not have an artificial turf area with synthetic grass, a desired portion of the hard plastic area may be removed using the same method that is described above.

With reference to FIGS. 1-2, a method of manufacturing golf mats adapted to displaying advertising includes attaching the first layer 14 to the second layer 16. Thus, the synthetic turf material is secured to the harder plastic or rubber material. Thereafter, a portion of the first layer corresponding to a location for displaying the advertising is removed. This creates the recess 18 in at least the first layer, although it is to be understood that the recess 18 may extend into the second layer 16 if a portion of the second layer is also removed. The shape of the recess 18 substantially corresponds to the lateral shape of the advertising element 20 that is meant to occupy the recess 18. As previously discussed, optionally, the base 26 may be secured within the recess 18.

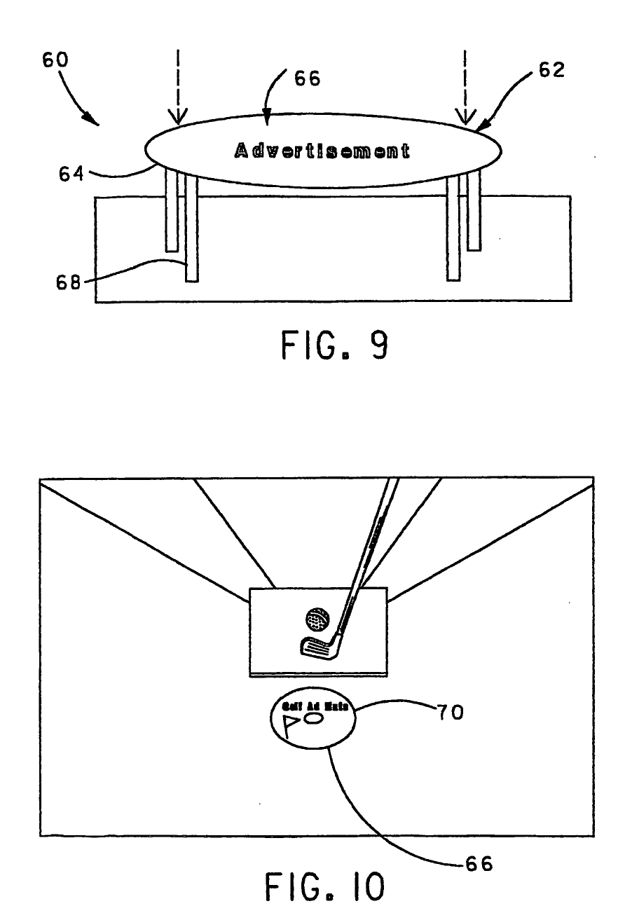

FIG. 9 depicts a first alternative embodiment advertising element 60 for use on a natural grass golf playing surface. The first alternative embodiment advertising element 60 includes a top side 62 and a bottom side 64. The top side 62 includes an advertisement 66 displayed thereon, whereas the bottom side 64 includes a plurality of prongs 68 extending therefrom. The plurality of prongs 68 may be any in number or size, such as four 10″ prongs. The plurality of prongs 68 are adapted to penetrate the golf playing surface to secure the first alternative embodiment advertising element 60 flush against the playing surface when the first alternative embodiment advertising element 60 is pushed in a downward direction against the playing surface, as indicated by the arrows in FIG. 9. The first alternative embodiment advertising element 66 may be constructed of any suitable material and may assume any suitable shape, as previously discussed in connection with the preferred embodiment of the present invention.

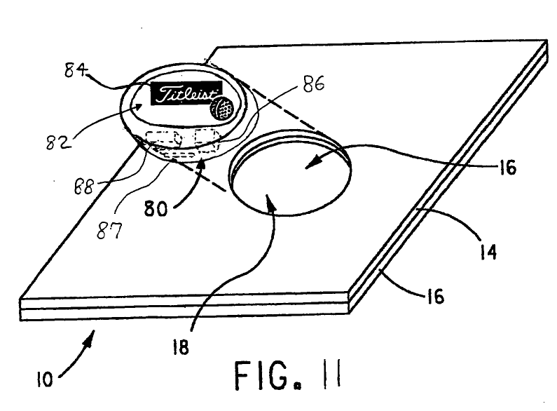

FIG. 10 depicts a second alternative embodiment advertising element 70 for use in miniature golf course environments. Specifically, the second alternative embodiment advertising element 70 includes the advertisement 66 displayed thereon, may be constructed of any suitable material, and may assume any suitable shape, as previously discussed in connection with the preferred embodiment of the present invention. Unlike the first alternative embodiment advertising element 60, the second alternative embodiment advertising element 70 does not include prongs. Therefore, the second alternative embodiment advertising element 70 is secured to the artificial or synthetic putting surface of the miniature golf course by way of adhesive or other type of fastener, as previously discussed.

With reference to FIG. 11, the advertising element may be an electronic device 80 associated with the golf mat 10. For example, the electronic device 80 may include a display unit 82 configured to display one or more advertisements 84 such as a message, a logo, or a combination thereof. Furthermore, in contrast to a non-electronic advertising element, the display unit 82 may also be configured to display video-based advertising content. The electronic device 80 may be embedded, attached, or integrated into the golf mat 10. It is to be understood that the advertisement 84 may contain any type of content desired to be conveyed to a user of the golf mat 10. Due to the specific environment (e.g., golfing area) in which the golf mat 10 is situated, the advertising appearing on the display unit 82 may be targeted for a specific demographic.

In accordance with a desirable embodiment of the present invention, the electronic device 80 is sized to be received in the recess 18 of the golf mat 10. The electronic device 80 may assume any suitable shape, as is discussed in connection with the preferred embodiment, above. It is to be understood that the electronic device 80 may be designed to fit within recesses having various depths. Furthermore, it is to be understood that the electronic device 80 may be secured within the recess 18 via any suitable fasteners, adhesives, or other techniques including, but not limited to, bonding agents, nails, screws, brackets, rivets, or stamping. Desirably, the electronic device 80 is a unitary structure having the necessary electronic components integrated therein. For example, in addition to housing the display unit 82, the electronic device 80 may include a processor 86, a storage medium 87, and a transceiver 88. It is to be understood that other components may be associated with the electronic device 80 and that any of the aforementioned and/or additional components may be communicatively connected to each other.

In the desirable embodiment, the display unit 82 is a liquid crystal display (LCD) based display. However, it is to be understood that the LCD display discussed herein is only an exemplary embodiment of a display type for use with the advertising element. Other suitable, but non-limiting displays include plasma, organic light emitting diode, and light emitting diode. It is to be understood that the display unit 82 may embody any suitable shape. Desirably, the display unit 82 is adapted to display text, a static image, and/or video in monochromatic and/or full color spectrum palettes. Accordingly, realistic images and videos may be shown by the display unit 82. It is to be understood that an animated image may be characterized as a video. As is known in the art, a traditional LCD monitor may include a thin plastic film covering that may provide adequate scratch and impact resistance against damage to the crystal arrangement in a home or office setting. However, as the present invention is to be utilized in conditions in which the display unit 82 is subjected to repeated impact via contact from a golf club or spiked golf shoes, it is envisioned that the display unit 82 may include a protective enclosure, such as a polycarbonate covering, that is resistant to scratches and impacts. Additionally, such a protective enclosure would inhibit moisture and dirt intrusion into the display unit 82. It is to be understood that the entire electronic device 80 may also be protected by such a protective enclosure or suitable equivalent.

As previously discussed, according to the desirable embodiment, the electronic device 80 includes the processor 86, the storage medium 87, and the transceiver 88. The electronic device 80 also includes software operative on the apparatus electronic device 80 and components thereof. The software may reside as firmware on the processor 86 or in other suitable hardware, such as the storage medium 87, associated with the electronic device 80. Exemplary storage mediums include, but are not limited to, volatile/non-volatile RAM, flash memory, a hard disk drive, an optical drive, or other suitable storage mediums. The storage medium 87 is configured to store advertising content thereon. For example, as shown in FIG. 11, the advertisement 84 shown on the display unit 82 depicts advertising for Titleist® golfing equipment. To effect the display of the advertisement 84 on the display unit 82, a corresponding data file, such as an image file, may be stored on the storage medium 87. The electronic device 80 is configured to support various image formats including, but not limited to, JPEG and GIF. In an exemplary embodiment, the processor 86 is configured to instruct the storage medium 87 to read the corresponding image file stored thereon and transmit the data along a data bus to a display driver configured to interpret the image file into a visual representation for display on the display unit 82. Accordingly, the advertisement 84 is displayed on the display unit 82 to be viewed by a user of the golf mat 10. The electronic device 80 is configured to support various video formats including, but not limited to, AVI, MPEG, QuickTime®, and Shockwave®. Access and display of advertisements embodied in a video format may be similar to that of advertisements embodied in an image format.

In an alternative embodiment, the processor 86 and or the transceiver 88 may be situated in a different portion of the mat 10, such that these components are remote from the display unit 82. For example, the processor 86 and the transceiver 88 may be sandwiched between the first layer 14 and the second layer 16. Thus, in contrast to the desirable embodiment, the display unit 82 may be embedded in the recess 18 as an individual component of the present invention. Appropriate communicative links may then be routed through the mat 10 to connect the remote processor 86, the storage medium 87, and transceiver 88 to the display unit 82.

The electronic device 80 is configured to display a variety of advertisements in a random, predetermined, or combination thereof order and timing. Desirably, the presentation of the advertisements is programmed to not distract the user during his or her swing. Accordingly, in a desirable embodiment, the currently displayed advertisement is only changed after the user swings, so as not to distract him or her during the swing. To this end, the golf mat 10 is configured to detect a swing performed by the user via a pressure sensor or suitable equivalent integrated in the golf mat 10. Desirably, the pressure sensor is in communicative connectivity with the electronic device 80. For example, once a club makes contact with the surface of the golf mat 10 during a swing, the pressure sensor is triggered, whereby the electronic device 80 changes the currently displayed advertisement 84. It is to be understood that other sensors may be utilized in connection with the golf mat 10 to act upon receipt of external stimuli and cause the electronic device 80 to respond accordingly. For example, rubber tees used in connection with golf mats may be adapted to detect swings. Furthermore, pressure sensors may be embedded in the surface of the golf mat 10 that can differentiate between the presence or absence of a golf ball and/or a user. For example, if a predetermined amount of time has lapsed in which such pressure sensors do not sense the weight that would indicate the presence of a user, the electronic device 80 may make the assumption that the previous user of the golf mat 10 has left. Thus, the same advertising presentation presented to the previous user may then be shown to the next detected user with the assumption that the next user will not be the previous user. The aforementioned use of sensing the presence and absence of users and swings are but examples of the ability to utilize sensors in connection with displaying, changing, and rotating advertisements. The electronic device 80 may also be configured to maintain statistical data regarding the types of advertisements and duration thereof that have been displayed. Such data may be useful for advertising purposes, such as establishing future advertising rates.

As is known in the art, golf mats are usually rotated a ¼ turn on a predetermined schedule (e.g., every week) to avoid uneven wear of the golfing surface. Thus, it is desirable to display the advertisement 84 in a proper and readable orientation regardless of the rotation imparted on the golfing surface. To this end, the golf mat 10 may employ a variety of techniques for ensuring this desired objective. In one embodiment, the electronic device 80 may rotate within the recess 18. In another embodiment, the display unit 82 may rotate independently within the electronic device 80. In yet another embodiment, software may be utilized to rotate the advertisement 84 in the proper orientation prior to display thereof on the display unit 82. With respect to the software implementation, a magnet or suitable equivalent detection technology may be utilized to allow the electronic device 80 to become aware of any golf mat rotation and automatically adjust the display of the advertisement 84 in response thereto.

Although the electronic device 80 is discussed herein with respect to wireless communications, it is to be understood that known wired networking technologies may be implemented. Desirably, the electronic device 80 is configured for wireless bidirectional communication with an external communications device. However, it is to be understood that the electronic device 80 may be configured for wireless unidirectional communication, such that the electronic device 80 is capable of only receiving data from the external communications device. As is known in the art, the transceiver 88 includes an antenna (not shown), which may be internal or external to the electronic device 80. The transceiver 88 and software operative thereon may be configured for any suitable wireless technology and protocol thereof. Desirably, the electronic device 80 utilizes radio communications conforming to predefined networking protocols (e.g., 102.11b/g). Use of such ubiquitous communications protocols provides for increased compatibility and ease of establishing a network infrastructure having multiple golf mats 10. Other exemplary wireless technologies may include, but are not limited to, infrared, optical, and microwave.

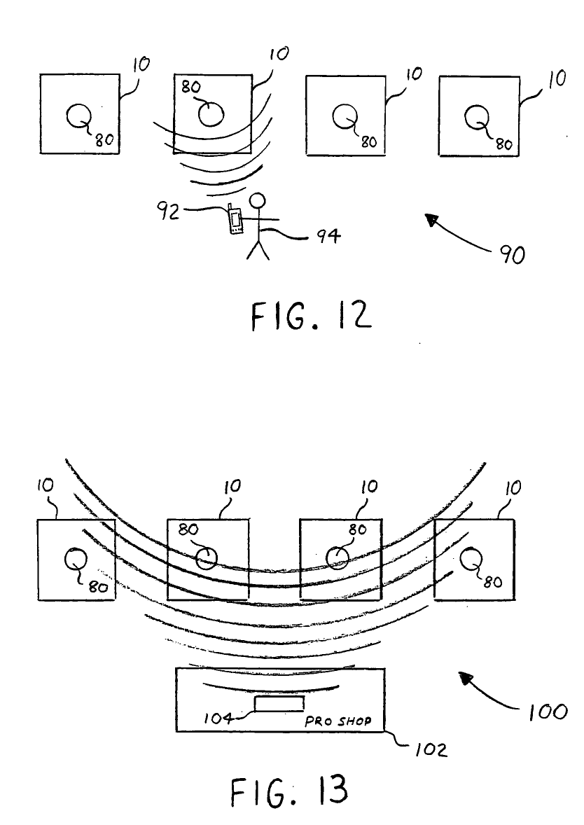

The electronic device 80 may be configured to receive advertising content and related programming from various sources. For example, as shown in FIG. 12, a golf mat advertising system 90 in accordance with a first embodiment may include a communications device 90, such as a handheld personal digital assistant (e.g., Palm Pilot®, Treo®, etc.), which may be configured to communicate with the electronic device 80 of the golf mat 10. It is to be understood that the communications device 90 may be any suitable computing device configured to establish a communications link between itself and the electronic device 80 and then transfer advertising content to the electronic device 80. The communications device 92 may include predefined advertising content and programming instructions. The programming instructions may relate to advertisement display settings including, but not limited to, the duration the advertisement is displayed and the frequency the advertisement is displayed. It is to be understood that the advertising content and the programming instructions may be created on and transferred from another computing device to the communications device 92. Alternatively, the advertising content and/or the programming instructions may be created on the communications device 92. By issuing an appropriate interrogation command, the communications device 92 may establish a communications channel with the electronic device 80. Thereafter, the advertising content and programming instructions are transferred to the electronic device 80 to be operative thereon. In the exemplary embodiment shown in FIG. 12, a plurality of golf mats 10 are positioned next to each other in a traditional driving range layout. An individual 94 may be charged with the task of transferring the advertising content and the programming instructions to the electronic devices 80 of one or more of the golf mats 10. Accordingly, the individual 94 may walk near each of the golf mats 10 and advertising content and programming instructions may be automatically or selectively transferred to each of the respective electronic devices 80. It is to be understood that each of the electronic devices 80 may be addressed individually, as a group, or as a subset of the group.

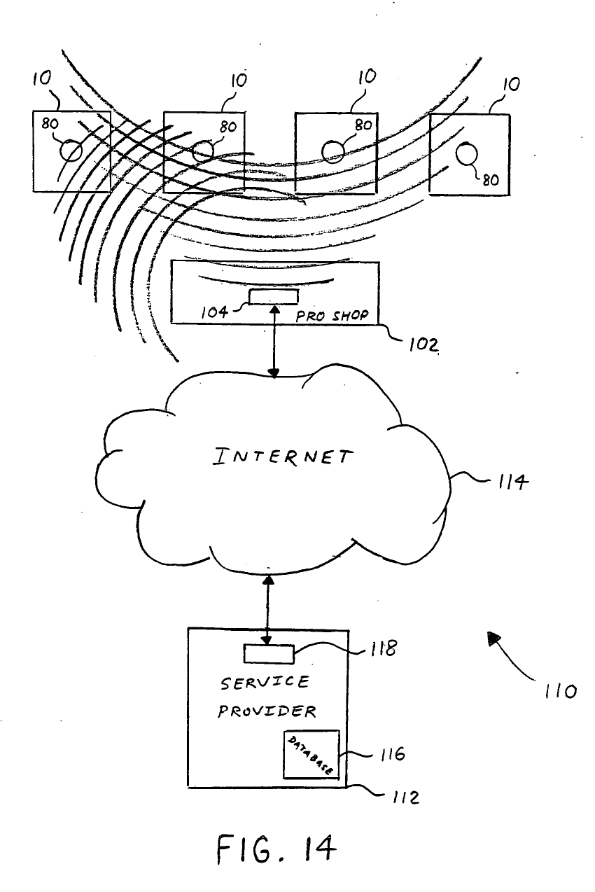

FIG. 13 illustrates a golf mat advertising system 100 in accordance with a second embodiment of the present invention. The golf mats 10 may be arranged in a traditional driving range layout. A pro shop 102 or other suitable structure, situated near the driving range, may house a computing device 104. Similar to the communications device 92, the computing device 104 is configured to transmit advertising content and programming instructions to each of the electronic devices 80 of one or more of the golf mats 10. The computing device 104 may be configured to modify the advertising content and programming instructions. Of course, it is to be understood that the transmission and reception properties of the computing device 104 and the electronic device 80 may be different from that of the communications device 92 and the electronic device 80 of the golf mat advertising system 90 due to the increased distance between the computing device 104 and the golf mats 80. However, use of the golf mat advertising system 100 eliminates the need to have the individual 94 interface with each golf mat 10 and perform advertising content and programming instruction updates thereon.

FIG. 14 illustrates a golf mat advertising system 110 in accordance with a third embodiment of the present invention. The golf mat advertising system 110 builds upon the golf mat advertising system 100 by incorporating a service provider 112 communicatively connected to the computing device 104 via a distributed communications network 114, such as the Internet. Desirably, the service provider 112 includes appropriate hardware and software configured to create, modify, and store advertising content and programming instructions in a database 116. Furthermore, the service provider 112 includes a server 118 configured to transmit the advertising content and programming instructions via the communications network 114 to the computing device 104. Thereafter, the computing device 104 transfers the advertising content and programming instructions to each of the electronic devices 80 of one or more of the golf mats 10. As shown in FIG. 14, one or more of the electronic devices 80 may be configured to transmit the aforementioned statistical data to the computing device 104, which in turn transmits the statistical data via the communications network 114 to the service provider 112. The statistical data may also be stored in the database 16 and may be used to modify existing advertising content and programming instructions or create new advertising content and programming instructions. It is to be understood that an advertiser may access the advertising content, programming instructions, and statistical data on the database 16.

The service provider 112 may maintain a dynamic communicative link with each of the electronic devices 80. The advertisements 84 may, therefore, be transmitted in real-time from the service provider 112 to the electronic device 80. Accordingly, the advertisements 84 need not necessarily reside permanently or temporarily reside within the storage medium 87 of the electronic device 80. Due to the dynamic communicative link established with the service provider 112, the electronic device 80 may display non-advertisement related information including, but not limited to, real-time news, sports scores, and weather forecasts received from the service provider 112.

In a fourth embodiment (not shown) of the present invention, it is envisioned that the service provider 112 may be communicatively connected to a satellite communications network. Thus, the transmission and reception of advertising content, programming instructions, and statistical data may be effected by satellite communications directly to and from the electronic device 80 of each of the golf mats 10. Consequently, the need for the computing device 104 and any communicative links associated therewith may be eliminated.

The electronic device 80 may also be utilized in connection with other golfing related structures. For example, the electronic device 80 may be embedded in a natural grass surface. Furthermore, an area adjacent to a golf mat, such as a concrete surface, may be adapted to receive the electronic device 80 therein. Thus, it is to be understood that the electronic device 80 is not limited to application involving direct integration with a golf mat. For example, a driving range may include a plurality of the golf mats 10 or any prior art golf mat. Typically, each golf mat and corresponding teeing area is separated from another adjacent golf mat and teeing area by a tee divider. It is envisioned that the electronic device 80 may be attached or integrated into such tee dividers'. It is also envisioned that the electronic device 80 may be attached or integrated into yardage markers at a teeing range. It is to be understood that slight modifications (e.g., sizing, power requirements, etc.) may be necessary to apply the electronic device 80 to other applications. As can be seen, the aforementioned advertising elements allow advertising to be placed in every imaginable golfing related location and environment.

The present invention has been described with reference to the preferred embodiments. Obvious modifications, combinations, and alterations will occur to others upon reading the preceding detailed description. It is intended that the invention be construed as including all such modifications, combinations, and alterations insofar as they come within the scope of the appended claims or the equivalents thereof.

1. A golf mat for displaying advertising, wherein the golf mat comprises:
a first layer having a top surface and a bottom surface, wherein the first layer is comprised of a synthetic turf material;
a second layer having a top surface and a bottom surface, wherein the second layer is comprised of one of a plastic and rubber material, wherein the first layer is attached to the second layer;
a recess extending into at least the top surface of the first layer; and
an advertising element having advertising displayed thereon, wherein the advertising element is situated within the recess.

2. The golf mat of claim 1, further comprising one of a fastener and adhesive for securing the advertising element within the recess.

3. The golf mat of claim 1, wherein the recess extends into the top surface of the second layer.

4. The golf mat of claim 3, further comprising a base substantially conforming to the lateral shape of the recess, wherein the base is secured within the recess.

5. The golf mat of claim 4, wherein the advertising element is secured to the base.

6. (canceled)

7. The golf mat of claim 1, wherein the advertising element is an electronic device having a display for displaying an electronic advertisement.

8. The golf mat of claim 7, wherein the electronic advertisement is one of text, a static image, and a video.

9. The golf mat of claim 7, wherein the electronic device includes a receiver for wirelessly receiving the electronic advertisement.

10. A method of displaying advertising in association with golf mats, the method comprising the steps of:
identifying a location on a golf mat for displaying the advertising, wherein the golf mat includes a first layer attached to a second layer;
removing a portion of at least the first layer of the golf mat corresponding to the location for displaying the advertising, whereby a first recess is created in the first layer; and
inserting an advertising element within the first recess, wherein the advertising element includes advertising displayed thereon.

11. The method of claim 10, wherein the portion of the first layer is removed by utilizing a router or a cutting tool.

12. The method of claim 11, further comprising the step of securing a template to the first layer, wherein the template includes a cut-out substantially corresponding to the lateral shape of the advertising element.

13. The method of claim 10, wherein the advertising element is secured within the first recess by one of fasteners, adhesives, and stamping.

14. The method of claim 10, wherein the advertising element is an electronic device having a display for displaying one of:
a textual advertisement;
an electronic static image advertisement; and
an electronic video advertisement.

15. A method for displaying an electronic advertisement in association with a golf mat, the method comprising the steps of:
providing a golf mat including an electronic device having an electronic display associated therewith; and
displaying the electronic advertisement on the electronic display.

16. The method of claim 15, further comprising the step of transmitting advertising content from a communications device to the electronic device, wherein the advertising content includes one or more electronic advertisements.

17. The method of claim 16, further comprising the step of transmitting programming instructions to the electronic device, wherein the programming instructions are operative on display settings of the one or more electronic advertisements.

18. The method of claim 16, further comprising the step of receiving statistical data from the electronic device, wherein the statistical data includes information relating to at least one of the duration and frequency of display of the one or more electronic advertisements.

19. The method of claim 15, further comprising the step of transmitting the electronic advertisement to the electronic device via a distributed communications network from a service provider remotely and communicatively connected to the electronic device.

20. The method of claim 15, wherein the electronic advertisement is one of:
a textual advertisement;
an electronic static image advertisement; and
an electronic video advertisement.

21. A golf mat for displaying advertising, wherein the golf mat comprises:
a first layer having a top surface and a bottom surface, wherein the first layer is comprised of a synthetic turf material;
a second layer having a top surface and a bottom surface, wherein the second layer is comprised of one of a plastic and rubber material, wherein the first layer is attached to the second layer;
a recess extending into at least the top surface of the first layer; and
an electronic device having a display for displaying an electronic advertisement, wherein the electronic device is situated within the recess, wherein the electronic advertisement is one of text, a static image, and a video.
